(19) United States
(12) Patent Application Publication
(10) Pub. No.: US 2008/0251145 A1
(43) Pub. Date: Oct. 16, 2008

(54) Shower 'N Time

(76) Inventor: Donald Dean Brunkhardt, Denver, CO (US)

Correspondence Address: Donald Dean Brunkhardt, 2942 S. Trenlon Street, Denver, CO, 80231, US

(21) Appl. No.: 12/080,183

(22) Filed: Apr. 1, 2008

Related U.S. Application Data
(60) Provisional application No. 60/921,544, filed on Apr. 3, 2007.

(51) Int. Cl. F17D 3/00

(52) U.S. Cl. 137/624.11

(57) ABSTRACT

A device that fits between a shower neck service pipe and a shower head. The water flowing through this device is controlled to provide a full-flow of water for a predetermined time frame. Once this time frame has expired, the device cuts off the flow of water by a substantial amount. This greatly reduced flow of water provides for less stimulation and enjoyment of showering and hastens the departure of the bather as well as conserves water and the energy needed to heat that water.

### RELATED APPLICATIONS

The present application is related to U.S. Pat. No. 6,016,836, issued Jan. 25, 2000, for WATER SAVER SHOWER, by Donald D. Brunkhardt, included by reference herein.

The present application is related to U.S. Pat. No. 6,899,133, issued May 31, 2005, for TIMED SHOWER VALVE MANAGER, by Donald D. Brunkhardt, included by reference herein.

The present application is a continuation application of U.S. provisional patent application Ser. No. 60/921,544, filed Apr. 3, 2007, for SHOWER 'N TIME, by Donald Dean Brunkhardt, included by reference herein and for which benefit of the priority date is hereby claimed.

### FIELD OF INVENTION

The present invention relates to controlling shower times and, more particularly, to limiting shower times through the means of a device attached to the shower head that is operated by a low voltage battery which device provides for a full flow of water for a preset time frame followed by a reduced flow of water.

### BACKGROUND OF THE INVENTION

Parents with teenage children have fought the battle for years of getting their kids out of the shower in a reasonable time frame. Many parents are “sick and tired” of their kids being late for the dinner table, late for the school bus, late for the carpool, late for soccer practice, or just being late for life. In many households, this battle of excessive showering times is a frequent event occurring daily if not multiple times during the day. Additionally, extended showering typically depletes hot water reserves and leaves the next person in line with a short or cold water shower. With the cost of natural gas and electric usage rates continuing to climb upward, extended showering has hit hard the budgets of households, dormitories, rental units, subsidized housings, locker rooms, etc., etc. In other areas of drought imposed water restrictions with surcharges or low producing domestic water wells, uncontrolled water usage can have a devastating effect on the availability and water reserves. Showering has long been recognized as one of the largest water users (and wasters) of domestic households.

There have been a number of solutions available over the years. Some practical and inexpensive, others more costly and somewhat effective, but few, if any, are reliable on a day-in/day-out basis over the long haul.

Some water districts in this country offer at low costs a 5-minute hour glass timer that attaches through suction to a shower wall. The intended purpose is to let the bather know when 5-minutes is up and time and voluntary vacate the shower. The intent is good, but few teenagers (and many adults for that matter) will continue with their normal showering habits as there is no force to get them to finish showering. Another approach is to place a restrictor orifice in the showerhead inlet thus limiting the amount of shower water used by bathers. Again, the potential benefit from using less water is inherent in this device, but if the bather continues to shower without either a forced or voluntary time limitation, the end results can be marginal. Many women don't like these devices, as well, as the restricted water flow does little to rinse out shampoo from a full head of hair.

Other devices like the Water Saving Shower (U.S. Pat. No. 6,016,836) and Timed Shower Valve Manager (U.S. Pat. No. 6,899,133) offer a non-voluntary approach to limiting shower times, but fall short in reliability as the wide range and variance (while using) of water pressure within a household cause these units, which control water delivery with solenoids, to frequently malfunction. Additional problems with these devices is that they are too easy to remove (teenager looking to extend showering time), do not cut the water flow enough to encourage cessation of showering, and the absence of visual or audible notification when the reset or restricted water flow time frame has expired. Another unit does limit shower times, but its unruly size (large as a parking meter) requires extensive retrofitting (inside the wall between the studs) and extension of a 110 volt electric line feed. The high cost of installation and the high initial cost of the unit make this an expensive and unpractical solution to showering water conservation and control.

The shortcomings of prior art have left a void for the need of an ineffective, reliable, and non-voluntary device that controls showering times. The need to limit showering times to help eliminate family feuds, the need to limit showering times to conserve water and the energy needed to heat that water, and the need to provide a fail-safe device with low operating costs is long overdue. To gain wide spread acceptance this device needs to be easy to install, easy to use, offer flexible time frames, difficult to disable or override, and pay for itself with water and energy savings within a short time frame, i.e., 12 months or less.

### SUMMARY OF THE INVENTION

In accordance with the present invention, there is provided . . . a device that fits between a shower neck service pope and a shower head. The water flowing through this device is controlled to provide a full-flow of water for a predetermined time frame. Once this time frame has expired, the device cuts off the flow of water by approximately 70%. This greatly reduced flow of water provides for less stimulation and enjoyment of showering and hastens the departure of the bather.

### BRIEF DESCRIPTION OF THE DRAWINGS

A complete understanding of the present invention may be obtained by reference to the accompanying drawings, when considered in conjunction with the subsequent, detailed description, in which:

For purposes of clarity and brevity, like elements and components will bear the same designations and numbering throughout the Figures.

### DETAILED DESCRIPTION OF THE INVENTION

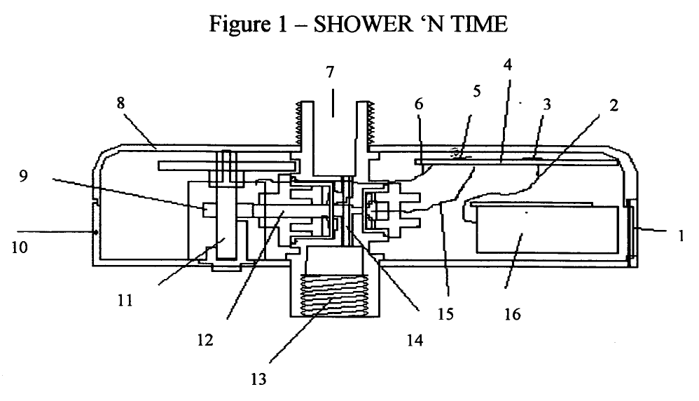

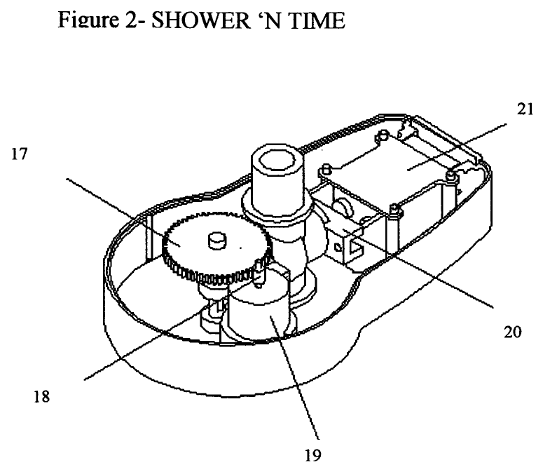

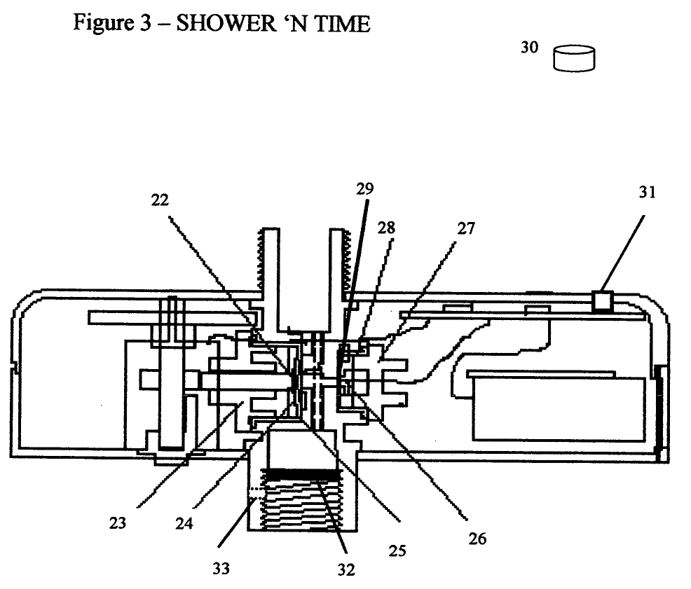

The SHOWER N' TIME is comprised of a 2-part water resistant case comprising the following: FIG. 1 gives a side internal perspective of a front cover 8 and a back cover 10 housing the following elements. A battery cover access panel 1, an electrical wire 2 connecting a battery 16 to a circuit board 4, a magnetic sensor 3, an alarm 5, an electric motor wire 6 connecting an electrical motor 19 of FIG. 2 and the circuit board 4 of FIG. 1. Also on FIG. 1 a flow-out tube 7, a cam 9 positioned on a drive shaft 11, a piston 12 with one end seated against the cam 9 and the other end inserted into a bypass bracket 23 of FIG. 3, a concave shaped bypass channel retainer washer 24 of FIG. 3 and seated against a bypass channel seal 25 of FIG. 3. On FIG. 1 a flow in tube 13, a main flow channel 14, an sensor wire 15 connection from the circuit board 4 to a sensor 26 of FIG. 3, a small gear 18 of FIG. 2 positioned on the shaft of the electric motor 19 of FIG. 2.

FIG. 2 provides a perspective view of the SHOWER 'N TIME with the front cover 8 removed. Elements include an electric motor 19, a large gear 17 positioned on the drive shaft 11, a small gear 18 positioned on the electric motor 19 shaft, a sensory bracket 20, and a battery retainer 21.

FIG. 3 provides a side internal perspective and identifies the following elements. The bypass channel 22, the bypass bracket 23, the bypass channel retainer washer 24, the bypass channel seal 25, a sensor switch 26, the sensor retainer 27, sensory retainer ring, a sensor seal 29, a magnet 30, a warning lamp 31, a washer 32, and a set screw 33.

The purpose of the SHOWER 'N TIME is to provide for a full-water flow shower for a predetermined time frame, and once this full-flow time frame expires, cut the full-flow of water significantly or by approximately 70%. The reduced water flow provides for water conservation and a less stimulating water flow to continue showering. Warnings of changes in water flow and a reset interval are built in.

### Operation

The SHOWER 'N TIME is connected to a shower delivery pipe that comes out of the shower wall/ceiling with the flow-in tube 13 and connects with a showerhead device with the flow-out tube 7.

As a main control valve to a shower is turned on, water begins to flow into the shower delivery pipe and into a SHOWER 'N TIME unit through the flow-in tube 13, and water continues to flow through the main flow channel 14 and out the flow-out tube 7. As water volume builds in the main flow channel 14, water pressure presses against the sensory seal 29 which closes the sensory switch 26, which, in turn, signals through sensory wire 15 the control board 4. The control board 4, in turn, sends an electrical current, through the electric motor wire 6, to the electric motor 19. The electrical current to the electric motor 19 is momentary in nature, just long enough to rotate the small gear 18 which is engaged to the large gear 17. The large gear 17 rotates the cam 9 on the drive shaft 11. The rotating cam 9 releases pressure on the piston 12, which is housed by the bypass bracket 23 and the bypass channel retainer washer 24, and was seated against the bypass channel seal 25 which blocked water from passing through the bypass channel 22. As the piston 12 retreats, the bypass channel seal 25 is restricted by the concave shape of the bypass channel retainer washer 24. Water now flows through the main flow channel 14 and the bypass channel 22 and exits out the flow out tube 7. The unit is now in full-flow water mode. At the same time a full-flow cycle timer starts in the circuit board.

As the unit approaches the end of the full-flow cycle, the timer sends a signal on the circuit board 4 to the alarm 5, also housed on the circuit board 4. The alarm 5 provides an audible tone letting the bather know the full-flow mode is about to end and the unit will advance into restricted water flow mode. Once the full-flow time expires the control board 4 outputs an electrical current through the electrical motor wire 6 to the electric motor 19. This momentary electrical current, however, to the electric motor 19 is of reversed polarity. This reversed electrical current rotates the small gear 18, the large gear 17, and the cam 9 in the opposite direction. This time the cam 9 forces the piston 12 to press firmly against the bypass channel seal 25 thus closing off the bypass channel 22. Water now flows through the main flow channel 14 only, which is approximately 30% of full-flow mode. The unit is now in restricted or conservation flow mode.

When the water is turned off at the main control valve for the shower, the water pressure in the main flow channel 14 drops and the input signal to the sensory switch 26 is lost. As soon as the control board 4 losses the input signal from the sensory switch 26, a delay timer (let's say 5 minutes) on the control board 4 is started. During this delay or reset interval, the unit is restricted from providing full-flow water delivery. Concurrent with the reset interval, a warning lamp 31, located on the control board 4, is turned on. The lighted warning lamp 31 gives notice to a bather the unit is in restricted mode and cannot provide a full-flow of water until the reset time interval has expired, at which time the warning lamp 31 will go off.

The restricted flow is the feature of the SHOWER 'N TIME that forces water conservation (including the heated water) and prompts the shower taker to finish showering as this restricted flow offers less than ideal showering conditions.

Programming the unit. Setting of the full-flow water time frame is accomplished by placing the magnet 30 over the indicated target zone just above the magnetic sensory 3 on the control board 4 while the unit is not in use. The unit will give an audible tone or string of tones from the alarm 5. The tone(s) corresponds to a time interval for a full-flow shower, i.e., 1 tone, 5 minutes; 2 tones 8 minutes, 3 tones 11 minutes, etc. The tones recycle once the program reaches the end of full-flow time settings. To set a full-flow time frame, the magnet 30 is held over the magnetic sensory 3 for the desired time that corresponds to the number of tones and then is removed. To verify the program setting, wait a few seconds and momentarily hold the magnet 30 over the magnetic sensor 3. The alarm 5 will beep the setting programmed. The device will retain the setting programmed until the setting is changed or until the battery is changed.

To help minimize the attempts of bathers removing the unit to avoid restricted or controlled showering, a set screw 33 is threaded into the wall of the flow-in tube 13. Tightening this set screw 33 firmly positions the device on the shower delivery pipe thus making it resistant to removal. To help prevent excessive torque on the threads of the flow-in tube 13, a washer 32 is inserted into the threaded area of the flow-in tube 13. This washer 32 provides a water tight seal as well as stop when the unit is threaded onto a shower service pipe, thus eliminating the excessive pressures on the flow-in tube 13 caused by torque when the unit is threaded onto a shower service pipe.

An important safety feature inherent in the operation of this unit is that the Shower Manager does not function as the main on/off water valve for the shower. Control of this important function, as well the mixture of hot/cold water, remains with the main shower valve installed on the shower. Also, the low-voltage battery 16 minimizes any electrical shock or hazard. Changing the battery is easily accomplished by accessing the battery 16 through the battery access panel 1. When the battery 16 runs low, the unit stays in the conservation or restricted flow mode until the battery 16 is replaced. Controls and settings are preset at the time of installation giving the unit a fully automated operation.

### CONCLUSION, RAMIFICATION AND SCOPE

The reader will see that the SHOWER 'N TIME is a practical, safe, updated and non-voluntary alternative to the prior art and appeases the agendas of parents, property managers, water districts, conservationists, etc.

While the SHOWER 'N TIME has been described with reference to particular embodiments, it is not intended to illustrate or describe all of the equivalent forms or ramification. Also, words used are words of description rather than limitation and various changes may be made without departing from the scope of the SHOWER 'N TIME.

I claim:

1) A programmable water flow control showering device comprising:
a) a hard shell housing;
b) a connection for inlet of water from a water source;
c) a main flow channel that contains a sensor switch held in place by a sensor bracket that activates when water pressure builds in the channel;
d) a sensor switch seal that provides for a watertight seal;
e) a channel divider that divides the water flow between the main flow channel and a bypass channel;
f) a bypass seal that covers the bypass channel that provides for a watertight seal;
g) an electric motor with a small gear on the motor shaft;
h) a drive shaft with a larger gear and a cam positioned in place by the housing covers;
i) a piston held in place by a bypass bracket;
j) a flow out tube providing for a connection to a showerhead;
k) a control board contained within the housing and containing logic circuits, timers, an alarm, a magnetic sensor, and an indicator lamp;
l) a battery compartment accessible from the external housing;
m) a low voltage power source;
n) a set screw embedded in the threads of the flow-in connection;
n) a magnet;
o) a washer located in the flow-in tube.

2) The invention defined in claim 1, wherein a first timer means activates signal producing means a predetermined time before closing of a valve.

3) The invention defined in claim 2, wherein the main flow channel is of such a size to substantially reduce the flow of water through the device when said valve is closed.

4) The invention defined in claim 2 wherein a timer prevents said valve from reopening before a predetermined time interval has expired.

5) The invention defined in claim 2 wherein an interval of time said valve remains open is predetermined.

6) The invention defined in claim 5 wherein a notification time, by alarm sounding, that said valve would close is predetermined.

7) The invention defined in claim 2 wherein a timer lights an indicator lamp and stays on until a predetermined time interval has expired.

8) The invention defined in claim 1 wherein the action of the motor rotates a gear set which, in turn, rotates a drive shaft that opens a valve. This process is reversed when the valve is closed.

9) The invention defined in claim 8 wherein the rotation of the cam releases pressure on the piston.

10) The invention defined in claim 1 wherein the opening of the bypass channel is achieved by the retreating piston and water pressure.

11) The invention defined in claim 1 wherein the tightening of the set screw against a water service pipe helps prevent removal of the device.

12) The invention defined in claim 5 wherein said intervals are determined after placing a magnetic device over the magnetic sensor and establishing said time intervals using audible tones.

13) The invention defined in claim 1 wherein said valve device could be powered by a low voltage power source.

14) The invention defined in claim 1 wherein the retreating of the bypass channel seal as water pressure pushes through the bypass channel is accommodated and restricted by a bypass channel washer which is concave shaped on the side facing the seal.

15) The invention defined in claim 1 where electrical wire connections from the battery to the control board, from the control board to the electric motor, and from the control board to the sensor switch send signals or current to activate the means for controlling the functions of the device.

16) The invention defined in claim 1 wherein the washer in the flow-in tube provides a means of restricting the degree of threading when the unit is placed on a water service pipe.
